(19) United States
(12) Patent Application Publication
(10) Pub. No.: US 2026/0340673 A1
(43) Pub. Date: Oct. 29, 2026

(54) METHOD FOR DERIVING IDIOSYNCRATIC PRICES ON FINANCIAL AND NON-FINANCIAL ASSETS

(71) Applicant: MoneyStation Inc., Seoul (KR)

(72) Inventor: Jungil LEE, Seoul (KR)

(73) Assignee: MoneyStation Inc., Seoul (KR)

(21) Appl. No.: 19/710,504

(22) Filed: Jun. 17, 2026

Related U.S. Application Data
(63) Continuation of application No. PCT/KR2024/018348, filed on Nov. 20, 2024.

(51) Int. Cl. G06Q 30/0201

(52) U.S. Cl. CPC G06Q 30/0206

(57) ABSTRACT

A server-implemented method separates an asset price into its market-driven and idiosyncratic prices to support investment decision-making. The server collects price information for a requested asset, calculates a market sensitivity β from daily returns of the asset and its market benchmark index, and derives an idiosyncratic price that reflects only asset-specific price movements independent of market conditions. The server then provides the user terminal with an actual price chart, an idiosyncratic price chart, and a market-driven price chart in an overlapping single graph, enabling users to identify relative undervaluation or overvaluation of the asset by comparing the idiosyncratic price against the actual price. The present invention was supported through the 2025 Seoul R&D Program (title: Deriving time-series of beta neutral prices of financial assets for institutional investors) through the Seoul Business Agency (SBA) funded by the Seoul Metropolitan Government.

### CROSS-REFERENCE TO RELATED APPLICATION

This application is a continuation of International Application No. PCT/KR2024/018348, filed on Nov. 20, 2024, the entire contents of which are herein incorporated by reference.

### BACKGROUND

### 1. Technical Field

The present invention relates to a method and system for calculating and providing an idiosyncratic price for an asset. More particularly, the present invention relates to a technology for collecting time-series information on an asset price and a market benchmark index, calculating market sensitivity β of the asset based thereon, deriving an idiosyncratic price component of the asset, and providing an actual price chart, an idiosyncratic price chart, and a market-driven price chart to a user terminal.

### 2. Related Art

Financial markets are subject to complex movements driven by various factors. For example, the price fluctuation of an individual stock is significantly affected not only by the overall market trend but also by the specific circumstances of the individual company. Investors need comprehensive analysis tools to understand this complexity and make more accurate investment decisions.

In particular, market sensitivity—which represents how sensitively the price of an individual asset responds to fluctuations in the overall market—is an important indicator for assessing investment risk, enabling investors to predict how a specific asset will respond to market movements.

In conventional technology, investment decisions have been made by simply comparing a composite price index with individual asset prices. However, this approach makes it difficult to obtain sufficient information necessary for investment judgment.

Therefore, there is a need for a technology that separates and analyzes market factors and individual factors through a method of calculating and providing an idiosyncratic price for an asset, enabling investors to more clearly identify the unique risks and opportunities of individual assets, and providing investors with more accurate and comprehensive financial analysis to support investment decision-making.

The present invention was supported through the 2025 Seoul R&D Program (title: Deriving time-series of beta neutral prices of financial assets for institutional investors) through the Seoul Business Agency (SBA) funded by the Seoul Metropolitan Government.

### SUMMARY

The present invention has been made to solve the foregoing problems of the prior art, and an object thereof is to calculate and provide an idiosyncratic price for an asset.

Another object of the present invention is to enable investors to more clearly identify the unique risks and opportunities of individual assets by separating and analyzing the asset price into market factors and individual factors, and to provide investors with more accurate, logical, and comprehensive financial investment analysis.

A further object of the present invention is to provide a particular manner of presenting and interacting with multi-layered financial time-series information on an electronic device. That is, derived price charts are overlaid on a single graph having a shared time axis and a shared price axis and are coherently synchronized across user operations; a relative undervaluation point and a relative overvaluation point are automatically detected based on a deviation threshold and are configured to be interactively selectable so as to display a quantitative deviation value; and an Idiosyncratic price computation is provided in response to a user-driven time range change or a data change. The present invention thereby improves the speed and functionality of the user interface for multi-layered chart analysis on an electronic device, and reduces the computational burden of the derived price series through a data structure and computational flow of the computation, rather than implementing the analytical method in a generic manner on a general-purpose computer.

The technical problems to be solved by the present invention are not limited to the technical problems mentioned above, and other technical problems not mentioned above will be clearly understood from the following description.

As a technical means for achieving the above-described technical problem, a method for calculating and providing an idiosyncratic price for an asset, performed by a server according to one embodiment of the present invention, comprises: (a) receiving a request for an idiosyncratic price for at least one asset from a user terminal, and collecting price information for the asset; (b) calculating a market sensitivity β of the asset based on a daily return of the asset and a daily return of a market benchmark index corresponding to the asset; (c) calculating an idiosyncratic price for a preset period based on the price of the asset and the market sensitivity β; and (d) displaying and providing at least one of an actual price chart, an idiosyncratic price chart, and a market-driven price chart of the asset to the user terminal, wherein the market-driven price chart may include a chart of a composite price index of a country in which the asset is located or of a group to which the asset belongs.

In addition, the price of the asset may be expressed as a sum of a market-driven price component corresponding to price fluctuations attributable to market factors and an idiosyncratic price component corresponding to price fluctuations attributable to asset-specific factors.

In addition, the step (b) may calculate the market sensitivity β of the asset by dividing a covariance between the daily return of the asset and the daily return of a market benchmark index corresponding to the asset by a variance of the daily return of the market benchmark index.

In addition, the step (b) may calculate the market sensitivity β of the asset by, according to a preset algorithm, multiplying a correlation coefficient between the daily return of the asset and the daily return of a market benchmark index corresponding to the asset by a standard deviation of the daily return of the asset, and dividing the result by a standard deviation of the daily return of the market benchmark index.

In addition, the step (c) may calculate an idiosyncratic return for the preset period by subtracting, from the return of the asset over the preset period, a market-driven return obtained by multiplying the market sensitivity β by the return of a market benchmark index over the preset period.

The idiosyncratic price time series may be generated recursively such that an initial idiosyncratic price at a starting time point is set equal to an actual price at the starting time point, and each subsequent idiosyncratic price is calculated by multiplying a preceding idiosyncratic price by 1 plus a corresponding idiosyncratic return.

In addition, the step (d) may display and provide the actual price chart, idiosyncratic price chart, market-driven price chart, and market benchmark index chart of the asset for which the price inquiry was requested to the user terminal as a single graph in which the charts are overlaid on one another.

In addition, the method may further comprise: (e) comparing the idiosyncratic price chart with the actual price chart of the asset at a time point received from the user terminal, determining whether the asset is relatively undervalued or relatively overvalued at the time point based on a comparison between the idiosyncratic price chart and the actual price chart, and providing a determination result to the user terminal.

In addition, the step (e) may determine that the asset is relatively undervalued when a value of the idiosyncratic price chart at the time point exceeds a value of the actual price chart at the time point, and determine that the asset is relatively overvalued when the value of the idiosyncratic price chart at the time point is less than the value of the actual price chart at the time point.

A server for calculating and providing an idiosyncratic price for an asset according to one embodiment of the present invention comprises: a memory storing a program for performing a method for calculating and providing an idiosyncratic price for an asset; and a processor for executing the program, wherein the method comprises: (a) receiving a request for an idiosyncratic price for at least one asset from a user terminal, and collecting price information for the asset; (b) calculating a market sensitivity β of the asset by considering a daily return of the asset and a daily return of a market benchmark index corresponding to the asset; (c) calculating an idiosyncratic price for a preset period based on the price of the asset and the market sensitivity β; and (d) displaying and providing at least one of an actual price chart, an idiosyncratic price chart, and a market-driven price chart of the asset to the user terminal, wherein the market-driven price chart includes a chart of a composite price index of the country in which the asset is located or of the group to which the asset belongs.

The present invention provides a method for calculating and providing an idiosyncratic price for an asset, thereby enabling users to separate and analyze market factors and individual factors and to more clearly identify the unique risks and opportunities of individual assets.

In addition, by comparing the idiosyncratic price with the actual price to evaluate the fair value of an asset, the present invention allows a user to determine whether an individual asset is currently relatively undervalued or overvalued in the market, thereby providing information to be used for investment decision-making.

In addition, by providing complex and vast financial data in chart form so that it can be easily and visually understood, the present invention can support users in making better decisions.

### BRIEF DESCRIPTION OF THE DRAWINGS

FIG. 1 is a structural diagram of a system for calculating and providing an idiosyncratic price for an asset, according to one embodiment of the present invention.

FIG. 2 is a block diagram showing the internal configuration of a server for calculating and providing an idiosyncratic price based on asset price, according to one embodiment of the present invention.

FIG. 3 is an illustration of formulas and variables used for calculating an idiosyncratic price according to one embodiment of the present invention.

FIGS. 4A and 4B are exemplary diagrams of an actual price chart, idiosyncratic price calculation, and a market-driven price chart, according to one embodiment of the present invention.

FIG. 5 is a flowchart of a sequence of performing a method for calculating and providing an idiosyncratic price based on an asset price, according to one embodiment of the present invention.

### DETAILED DESCRIPTION OF THE EMBODIMENTS

Hereinafter, embodiments of the present invention will be described in detail with reference to the accompanying drawings so that those skilled in the art to which the present invention pertains may easily carry out the invention. However, the present invention may be implemented in various different forms and is not limited to the embodiments described herein. In the drawings, parts unrelated to descriptions are omitted for clarity of illustration, and like reference numerals are used for like parts throughout the specification.

Throughout the specification, when a part is described as being “connected” to another part, this includes not only the case of being “directly connected” but also the case of being “electrically connected” with another element interposed therebetween. Also, when a part is described as “including” a component, this means that the part may further include other components, rather than excluding them, unless otherwise specifically stated.

In this specification, the term “unit” includes a unit realized by hardware, a unit realized by software, and a unit realized using both. In addition, one unit may be realized using two or more pieces of hardware, and two or more units may be realized by one piece of hardware. Meanwhile, “^{~}unit” is not limited to software or hardware, and “^{~}unit” may be configured to be in an addressable storage medium or may be configured to reproduce one or more processors. Accordingly, as one example, “^{~}unit” includes components such as software components, object-oriented software components, class components, and task components; processes, functions, attributes, procedures, subroutines, segments of program code, drivers, firmware, microcode, circuits, data, databases, data structures, tables, arrays, and variables. The functionality provided within the components and “^{~}units” may be combined into a smaller number of components and “^{~}units” or further separated into additional components and “^{~}units.” Furthermore, the components and “^{~}units” may be implemented to reproduce one or more CPUs within a device or a secure multimedia card.

The term “terminal” referred to below may be implemented as a computer or portable terminal capable of connecting to a server or other terminal through a network. Here, the computer may include, for example, a laptop, a desktop, a laptop computer equipped with a web browser, and a VR HMD (e.g., HTC VIVE, Oculus Rift, GearVR, DayDream, PSVR, etc.). Here, the VR HMD includes those for PC (e.g., HTC VIVE, Oculus Rift, FOVE, Deepon, etc.), those for mobile (e.g., GearVR, DayDream, etc.), those for console (PSVR), and Stand Alone models (e.g., Deepon, PICO, etc.) implemented independently. A portable terminal is, for example, a wireless communication device with guaranteed portability and mobility, and may include not only smartphones, tablet PCs, and wearable devices, but also various devices equipped with communication modules such as Bluetooth (BLE, Bluetooth Low Energy), NFC, RFID, ultrasonic, infrared, Wi-Fi, and LiFi. In addition, “network” refers to a connection structure through which each node, such as terminals and servers, can exchange information with each other, and includes a Local Area Network (LAN), a Wide Area Network (WAN), the Internet (WWW: World Wide Web), wired and wireless data communication networks, telephone networks, wired and wireless television communication networks, and the like. Examples of wireless data communication networks include, but are not limited to, 3G, 4G, 5G, 3GPP (3rd Generation Partnership Project), LTE (Long Term Evolution), WiMAX (World Interoperability for Microwave Access), Wi-Fi, Bluetooth communication, infrared communication, ultrasonic communication, Visible Light Communication (VLC), LiFi, and the like.

The present invention relates to a method and system for calculating and providing an idiosyncratic price for an asset. Upon a user's request, price information of an asset and a market benchmark index are collected, market sensitivity is calculated based thereon, an idiosyncratic price is computed, and the actual price chart 500, idiosyncratic price chart 300, and market-driven price chart 400 are provided to the user.

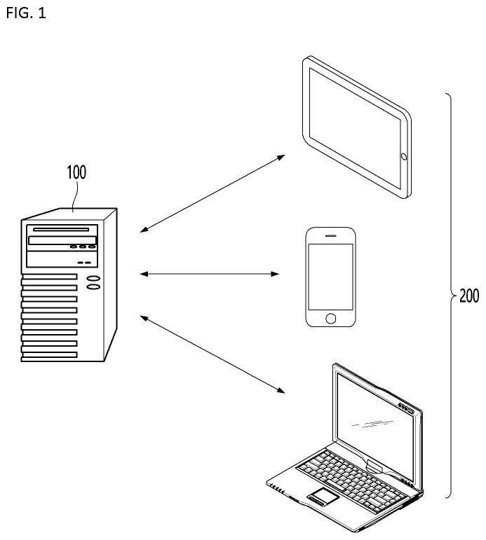

Referring to FIG. 1, the system for calculating and providing an idiosyncratic price based on asset price according to one embodiment of the present invention may be configured to include a server 100 and a user terminal 200 as illustrated.

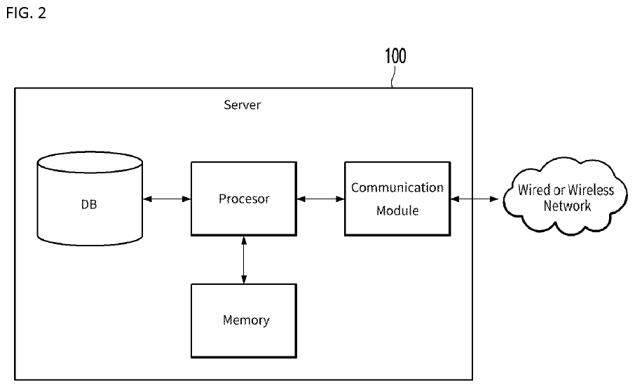

Referring to FIG. 2, the server 100 according to one embodiment of the present invention may be configured to include a memory storing a program (or application) that performs a method for calculating and providing an idiosyncratic price based on asset price, and a processor that executes the program. Here, the processor may perform various functions according to the execution of the program stored in the memory.

In addition, the server 100 may include a built-in communication module that can communicate with the user terminal 200 via wired or wireless communication, and a database (DB) in which predetermined data for performing the method for calculating and providing an idiosyncratic price based on asset price is stored.

Meanwhile, the user terminal 200 according to one embodiment of the present invention has a program or application for performing the method for calculating and providing an idiosyncratic price based on asset price pre-installed therein, and may be implemented in the form of a desktop, laptop, tablet PC, or smartphone, and may communicate with the server 100 via wired or wireless connection.

Hereinafter, one embodiment of the method for calculating and providing an idiosyncratic price based on asset price performed through the system described above will be described.

According to the method for calculating and providing an idiosyncratic price based on asset price according to one embodiment of the present invention, the server 100 first receives a request for an idiosyncratic price for at least one asset from the user terminal 200, and collects price information for the received asset.

At this time, the price information collected by the server 100 may be the actual price information of the asset and the market benchmark index information. The actual price may be the sum of a market-driven price corresponding to price fluctuations due to market influences on the asset and an idiosyncratic price corresponding to price fluctuations due to the individual circumstances of the asset company (the idiosyncratic price is calculated through a process to be described later). The market benchmark index information may include the composite price index of the corresponding country announced by a major financial institution or stock exchange.

In addition, the market benchmark index of the present invention may include, in addition to the composite price index of the corresponding country described above, various price indicators representing the value of a market/asset/country, such as a representative virtual asset index, a real estate price index, a dollar index, and the like.

For example, when the asset received by the server 100 from the user terminal 200 is a stock of Company S in the Republic of Korea, the server 100 may collect the price of Company S's stock as the actual price information and KOSPI (Korea Composite Stock Price Index) as the market benchmark index.

The server 100 calculates the market sensitivity β of the asset based on the daily return of the asset thus collected and the daily return of a market benchmark index corresponding to the asset.

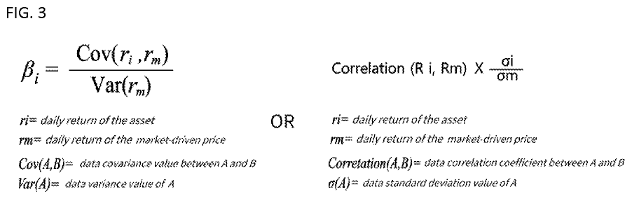

Referring to FIG. 3, the market sensitivity β according to one embodiment of the present invention may be calculated by dividing a covariance between the daily return of the asset and the daily return of a market benchmark index corresponding to the asset by a variance of the daily return of the market benchmark index. The market sensitivity β may be a fixed value or a changing value updated daily.

In addition, in another embodiment of the present invention, the market sensitivity β may be learned and calculated through an Artificial Intelligence (AI) learning method, or may be calculated through various techniques such as statistical methods such as multivariate regression models or latent factor models, or recurrent neural network models.

Meanwhile, according to various embodiments of the present invention, the market sensitivity β may also be calculated by, according to a preset algorithm, multiplying a correlation coefficient between the daily return of the asset and the daily return of a market benchmark index corresponding to the asset by a standard deviation of the daily return of the asset, and dividing the result by a standard deviation of the daily return of the market benchmark index.

The market sensitivity β calculated in the above manner is data used to distinguish individual factors from external/exogenous factors when analyzing financial asset price time-series data in industry/economic research and financial investment sectors, and may refer to an indicator of how much a specific financial product has been influenced by the market benchmark index of the country to which the financial product belongs.

For example, using the previously cited example of Company S stock in the Republic of Korea, when Company S's stock price drops not due to individual factors occurring solely within Company S—such as replacement of the CEO or a fire at a major plant of Company S—but rather drops along with the KOSPI, the magnitude of the drop in Company S's stock at this time may be related to market sensitivity β, which is an indicator of how much the financial product has been influenced by the market benchmark index of the country to which the financial product belongs.

This is a technical feature of the present invention that distinguishes it from the prior art. Through this, the present invention can identify the contribution of each individual and external (market) factor to price fluctuations. By separating the factors affecting the prices described above through the process to be described later and providing them in chart form, the present invention can provide additional information (market impact sensitivity for each asset) to domestic and foreign users (analysts/media/investors/policy institutions).

Returning to the subject, the server 100 calculates an idiosyncratic price for a preset period based on the collected asset price and the calculated market sensitivity β.

The idiosyncratic price according to one embodiment of the present invention may be calculated by subtracting, from the return of the asset over the preset period, a market-driven return obtained by multiplying the market sensitivity β by the return of a market benchmark index over the period, to obtain an idiosyncratic return.

That is, when the idiosyncratic price and actual price at the initial time point at which calculation of the idiosyncratic price begins (e.g., the first day) are referred to as Idiosyncratic Price 1 and Actual Price 1, respectively, the initially calculated idiosyncratic price is: Idiosyncratic Price 1=Actual Price 1, and thereafter, the idiosyncratic price on the next day (the 2nd day from the initial calculation date): Idiosyncratic Price 2=Actual Price 1×(1+Rate of Change of Idiosyncratic Price 1).

Subsequently, at the next calculation time point (e.g., the 3rd day from the initial calculation date): Idiosyncratic Price 3=Idiosyncratic Price 2×(1+Rate of Change of Idiosyncratic Price 2).

Accordingly, the subsequent calculation of idiosyncratic prices may be carried out as: Idiosyncratic Price n=Idiosyncratic Price (n−1)×(1+Idiosyncratic Price Rate of Change (n−1)).

The market sensitivity β may be a fixed value or a value that changes daily. In addition, the return of the market benchmark index may also have a different value each day. That is, the idiosyncratic return may have a different value each day. Therefore, the idiosyncratic price may be a value calculated anew each day. The idiosyncratic price may move independently of the actual price or market-driven price, rather than following the trends of the actual price or market-driven price.

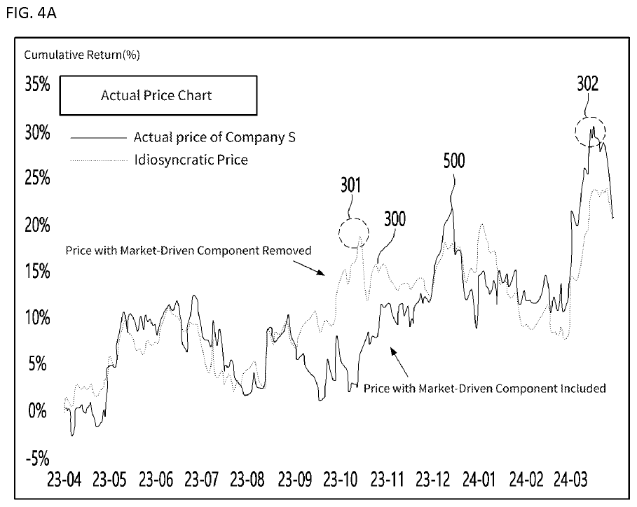

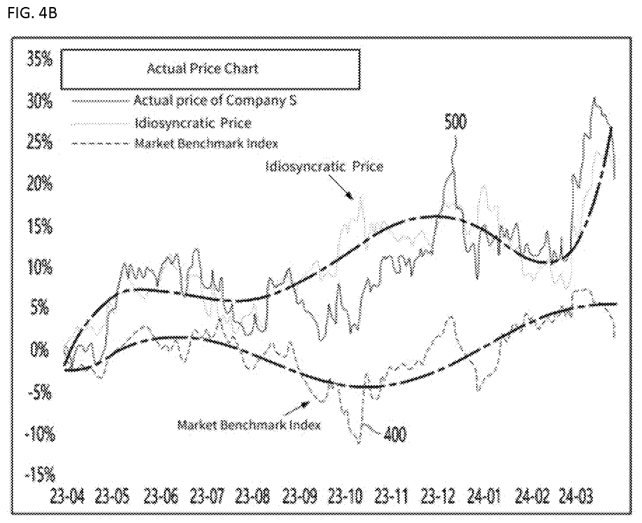

Referring to FIGS. 4A and 4B, as illustrated, the server 100 may display and provide to the user terminal 200 the actual price chart 500, idiosyncratic price chart 300, and market-driven price chart 400 of the asset.

At this time, each chart provided to the user terminal 200 may be provided individually or two or three of them may be provided together. In a preferred embodiment, the actual price chart 500, idiosyncratic price chart 300, market-driven price chart 400, and market benchmark index chart of the asset for which the price inquiry was requested may be displayed and provided as a single graph in which the charts are overlaid on one another.

In addition, according to one embodiment of the present invention, the idiosyncratic price chart 300 and market-driven price chart 400 may be displayed in a dotted line or color distinguishable from the actual price chart 500.

Here, since the idiosyncratic price chart 300 refers to the price from which market influence has been removed from the actual price chart 500, the server 100 may, taking this into account, determine the point where the price difference between the two charts is at its maximum or exceeds a preset value as a (relative to intrinsic value) relative undervaluation point 301 or (relative to intrinsic value) relative overvaluation point 302.

For example, as illustrated, when the price chart of Company S stock shows that the actual price is lower than the price based on individual factors (price based on intrinsic value) between October 2023 and November 2023, and it is determined that there is a relative undervaluation point 301, in an additional embodiment of the present invention, a circular dotted identifier is displayed at the corresponding point. When the identifier is selected and input by the user terminal 200, a text or pop-up notification may be provided on the graph informing that, at that point, Company S's actual price should be formed at a much higher level when viewed only from Company S's individual factors excluding the KOSPI trend.

Based on such pop-up notifications and texts, the user can compare the idiosyncratic prices and actual price fluctuations among companies in the same sector as Company S to determine which analysis target has relatively solid/poor fundamentals, and then select investment targets and make investment decisions.

For example, when the market-driven price has declined but the price due to individual factors has not declined, chart analysis of this type can show that the recent price decline was driven by market influences rather than a deterioration of the company's own fundamentals. Conversely, a user can confirm that the fundamentals of the company itself have deteriorated and decide to hold off on further investment. Information that cannot be obtained from conventional commercialized price charts can be obtained through the present invention, and an investor in the relevant asset can form a rational perspective on a price decline occurring for no apparent reason.

On the other hand, as illustrated, when the price chart of Company S stock shows that the actual price is higher than the price based on individual factors (price based on intrinsic value) after March 2024, and it is determined that there is a relative overvaluation point 302, in an additional embodiment of the present invention, a circular dotted identifier is displayed at the corresponding point. When the identifier is selected and input by the user terminal 200, a text or pop-up notification may be provided on the graph informing that, at that point, Company S's actual price should be formed at a much lower level when viewed only from Company S's individual factors excluding the KOSPI trend.

Meanwhile, according to an additional embodiment of the present invention, the server 100 may compare the idiosyncratic price chart 300 with the actual price chart 500 of the asset at a time point received from the user terminal 200, determine whether the asset is relatively undervalued or relatively overvalued at the time point based on a comparison between the idiosyncratic price chart 300 and the actual price chart 500, and provide a determination result to the user terminal 200. For example, the determination result regarding investment decision-making may be provided as follows.

TABLE 1

| Market-driven Price | Idiosyncratic Price | Investment Decision |
|---|---|---|
| Rise | Rise | Hold |
| Rise | Flat | Hold |
| Rise | Fall | Neutral |
| Flat | Rise | Hold |
| Flat | Flat | Neutral |
| Flat | Fall | Liquidate |
| Fall | Rise | Neutral |
| Fall | Flat | Liquidate |
| Fall | Fall | Liquidate |

In addition, a market outlook (e.g., outlook for rise or fall) for the asset may also be provided with reference to the market-driven price and idiosyncratic price.

In this embodiment, the server 100 may determine, when the value of the idiosyncratic price chart 300 at the time point is greater than the value of the actual price chart 500 of the asset, that the asset is relatively undervalued, and when the value of the idiosyncratic price chart 300 at the time point is less than the value of the actual price chart 500 at the time point, determine that the asset is relatively overvalued.

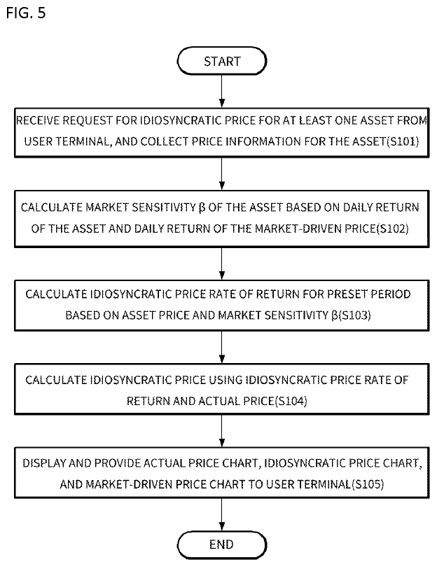

Hereinafter, the sequence of performing the method for calculating and providing an idiosyncratic price for an asset according to one embodiment of the present invention will be described once more with reference to FIG. 5.

According to the method for calculating and providing an idiosyncratic price for an asset according to one embodiment of the present invention, first, the server 100 receives a request for an idiosyncratic price for at least one asset from the user terminal 200 and collects price information for the asset (S101).

The server 100 calculates the market sensitivity β of the asset based on the daily return of the asset and the daily return of a market benchmark index corresponding to the asset (S102).

The server 100 calculates the idiosyncratic return for the preset period based on the price of the asset and the market sensitivity β (S103).

Thereafter, the idiosyncratic price is calculated by computing the idiosyncratic return and the actual price (S104).

Next, at least one of the actual price chart 500, idiosyncratic price chart 300, and market-driven price chart 400 of the financial product for which the price inquiry was requested is displayed and provided to the user terminal 200 (S105).

According to a further embodiment of the present invention, the server 100 and the user terminal 200 may cooperatively render an actual price chart 500, an idiosyncratic price chart 300, a market-driven price chart 400, and a market benchmark index chart as overlaid layers on a single graph having a shared time axis and a shared price axis. When the user terminal 200 receives a zoom input, a pan input, or a time range selection input via an interactive user interface, the user terminal 200 applies an identical time-axis transformation to each of the overlaid layers, such that visual alignment between corresponding time points across the layers is maintained at every zoom level. Additionally, the server 100 recalculates a market sensitivity β based on daily returns over the selected time range and transmits the recalculated idiosyncratic price values to the user terminal 200, such that the overlaid layers are updated in real time.

According to another further embodiment of the present invention, the server 100 may store an asset price, the market sensitivity β, an idiosyncratic return, and an idiosyncratic price time series in a data structure indexed by a composite key of an asset identifier and a time point identifier. When any one of the B value at a given time point, the daily return of the asset, or the daily return of the market benchmark index is changed, the server 100, based on a structure in which the idiosyncratic price time series is recursively computed from the idiosyncratic price at an immediately preceding time point (that is, Idiosyncratic price (n)=Idiosyncratic price (n−1)×(1+Idiosyncratic Price Rate of Change (n−1))), invalidates the cached idiosyncratic price values at the given time point and at every subsequent time point. Meanwhile, the cached values at preceding time points that are not affected are preserved. The server 100 then recursively recomputes only the invalidated values, starting from the earliest invalidated time point, thereby achieving a computational cost proportional to the number of affected time points rather than the total length of the time series. The present invention reduces the computational burden of the derived price series by employing a computational flow in which, in response to a user-driven time range change or a data change at a particular time point, only the cached idiosyncratic price values at the affected time point and at every subsequent time point are invalidated and recursively recomputed, while the cached values at unaffected preceding time points are preserved. This differs from conventional approaches in which, upon any change in the input data or the displayed time range, the entire derived price series is recomputed from the starting time point, resulting in a computational cost that scales linearly with the total length of the time series and with the number of assets analyzed in parallel.

According to another further embodiment of the present invention, the server 100 may automatically detect the relative undervaluation point 301 and the relative overvaluation point 302 by computing, at each time point within the displayed time range, a deviation value between the idiosyncratic price chart 300 and the actual price chart 500, and comparing the deviation value to a deviation threshold. For example, the deviation threshold may be set as a mean of the deviation values across the displayed time range, a predetermined percentile of the distribution of the deviation values, or a fixed value preconfigured by the user terminal 200, but is not necessarily limited thereto. When the deviation value at a given time point exceeds the deviation threshold and the actual price chart 500 is positioned below the idiosyncratic price chart 300, the server 100 marks the given time point as the relative undervaluation point 301; when the actual price chart 500 is positioned above the idiosyncratic price chart 300, the server 100 marks the given time point as the relative overvaluation point 302.

According to another further embodiment of the present invention, the relative undervaluation point 301 and the relative overvaluation point 302 are configured as interactively selectable elements. When the user terminal 200 receives a selection input directed to the relative undervaluation point 301 or the relative overvaluation point 302, the user terminal 200 may display, in response, a popup notification overlaid on the chart. The popup notification includes at least one of: the value of the idiosyncratic price chart 300 at the selected time point; the value of the actual price chart 500 at the selected time point; the deviation value therebetween; and an explanatory text indicating whether the actual price at the selected time point is in a relatively undervalued state or in a relatively overvalued state.

Furthermore, according to another further embodiment of the present invention, the user terminal 200 may receive, via the interactive user interface, an input selecting a subset of chart layers to be displayed. When the user terminal 200 receives an input deactivating a particular chart layer (e.g., the market benchmark index chart), the server 100 suspends computation and transmission for the time series corresponding to the deactivated layer, and performs the recalculation of the market sensitivity β and the update of the idiosyncratic price values only for the activated layers. Additionally, upon switching between activation and deactivation of a layer, the user terminal 200 preserves the zoom level, the time range, and the state of the detected relative undervaluation point 301 and relative overvaluation point 302 for the layers that remain in an activated state, thereby preventing loss of visual context due to the layer switching.

In addition, the present invention improves the speed and functionality of the user interface for multi-layered chart analysis by (i) rendering an actual price chart, an idiosyncratic price chart, a market-driven price chart, and a market benchmark index chart as overlaid layers on a single graph having a shared time axis and a shared price axis, in which visual alignment between corresponding time points across the layers is maintained at every zoom level under user-driven zoom, pan, and time range selection operations, (ii) automatically detecting relative undervaluation points and relative overvaluation points within the displayed time range based on a deviation threshold between the idiosyncratic price chart and the actual price chart, and visually marking such detected points on the chart as interactively selectable elements, and (iii) displaying, in response to a user selection input directed to such a marked point, a popup notification including a quantitative deviation value and an explanatory text indicating whether the actual price at the selected time point is in a relatively undervalued or relatively overvalued state.

One embodiment of the present invention may also be implemented in the form of a recording medium including instructions executable by a computer, such as a program module executed by a computer. Computer-readable media can be any available media that can be accessed by a computer and includes both volatile and non-volatile media, removable and non-removable media. In addition, computer-readable media may include all computer storage media. Computer storage media includes both volatile and non-volatile, removable and non-removable media implemented in any method or technology for storage of information such as computer-readable instructions, data structures, program modules, or other data.

Although the methods and systems of the present invention have been described in connection with specific embodiments, some or all of their components or operations may be implemented using a computer system with general-purpose hardware architecture.

The foregoing description of the present invention is intended for illustrative purposes, and a person skilled in the art to which the present invention belongs will understand that the present invention can be easily modified into other specific forms without changing the technical spirit or essential features of the present invention. Therefore, the embodiments described above should be understood to be illustrative in all respects and not restrictive. For example, each component described as a single type may be implemented in a distributed manner, and similarly, components described as being distributed may also be implemented in a combined form.

The scope of the present invention is indicated by the appended claims rather than the detailed description above, and all changes or modifications derived from the meaning and scope of the claims and their equivalent concepts should be interpreted as being included within the scope of the present invention.

### REFERENCE NUMERALS

100: Server 200: User Terminal
300: Idiosyncratic Price Chart
302: Relative Overvaluation Point
500: Actual Price Chart
301: Relative Undervaluation Point
400: Market-Driven Price Chart

What is claimed is:

1. A method for calculating and providing an idiosyncratic price for an asset, performed by a server, the method comprising:
(a) receiving a request for an idiosyncratic price for at least one asset from a user terminal, and collecting price information for the asset;
(b) calculating a market sensitivity β of the asset based on a daily return of the asset and a daily return of a market benchmark index corresponding to the asset;
(c) calculating an idiosyncratic price for a preset period based on a price of the asset and the market sensitivity β; and
(d) displaying and providing, to the user terminal, at least one of an actual price chart, an idiosyncratic price chart, and a market-driven price chart of the asset,
wherein the market-driven price chart includes a chart of a composite price index of a country in which the asset is located or of a group to which the asset belongs.

2. The method of claim 1, wherein:
the price of the asset is a sum of a market-driven price component corresponding to a price fluctuation attributable to market factors, and an idiosyncratic price component corresponding to a price fluctuation attributable to asset-specific factors.

3. The method of claim 1, wherein:
the step (b) calculates the market sensitivity β of the asset by dividing a covariance between the daily return of the asset and the daily return of a market benchmark index corresponding to the asset by a variance of the daily return of the market benchmark index.

4. The method of claim 1, wherein:
the step (b) calculates the market sensitivity β of the asset by, according to a preset algorithm, multiplying a correlation coefficient between the daily return of the asset and the daily return of a market benchmark index corresponding to the asset by a standard deviation of the daily return of the asset, and dividing the result by a standard deviation of the daily return of the market benchmark index.

5. The method of claim 1, wherein:
the step (c) calculates an idiosyncratic return for the preset period by subtracting, from the return of the asset over the preset period, a market-driven return obtained by multiplying the market sensitivity β by the return of a market benchmark index over the preset period.

6. The method of claim 5, wherein:
the idiosyncratic price is calculated such that:
an initial idiosyncratic price at a starting time point is set equal to an actual price at the starting time point;
each subsequent idiosyncratic price is calculated by multiplying a preceding idiosyncratic price by 1 plus a corresponding idiosyncratic return; and
an N-th idiosyncratic price is calculated by multiplying the (N−1)-th idiosyncratic price by 1 plus the (N−1)-th idiosyncratic return.

7. The method of claim 1, wherein:
the step (d) displays and provides the actual price chart, idiosyncratic price chart, market-driven price chart, and market benchmark index chart of the asset for which the price inquiry was requested to the user terminal as a single graph in which the charts are overlaid on one another.

8. The method of claim 1, further comprising:
(e) comparing the idiosyncratic price chart with the actual price chart of the asset at a time point received from the user terminal, determining whether the asset is relatively undervalued or relatively overvalued at the time point based on a comparison between the idiosyncratic price chart and the actual price chart, and providing a determination result to the user terminal.

9. The method of claim 8, wherein:
the step (e) determines that the asset is relatively undervalued when a value of the idiosyncratic price chart at the time point exceeds a value of the actual price chart at the time point, and
determines that the asset is relatively overvalued when the value of the idiosyncratic price chart at the time point is less than the value of the actual price chart at the time point.

10. A server for calculating and providing an idiosyncratic price for an asset, the server comprising:
a memory storing a program for performing a method for calculating and providing an idiosyncratic price for an asset; and
a processor for executing the program,
wherein the method comprises:
(a) receiving a request for an idiosyncratic price for at least one asset from a user terminal, and collecting price information for the asset;
(b) calculating a market sensitivity β of the asset based on a daily return of the asset and a daily return of a market benchmark index corresponding to the asset;
(c) calculating an idiosyncratic price for a preset period based on a price of the asset and the market sensitivity β; and
(d) displaying and providing, to the user terminal, at least one of an actual price chart, an idiosyncratic price chart, and a market-driven price chart of the asset, and
wherein the market-driven price chart includes a chart of a composite price index of the country in which the asset is located or of the group to which the asset belongs.
